(19) United States
(12) Patent Application Publication
(10) Pub. No.: US 2007/0040881 A1
(43) Pub. Date: Feb. 22, 2007

(54) Inkjet ink composition, ink cartridge including the same, and inkjet recording apparatus including the ink cartridge

(75) Inventors: Cheol Ham, Yongin-si (KR); Seung-min Ryu, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/496,484

(22) Filed: Aug. 1, 2006

(30) Foreign Application Priority Data
Aug. 17, 2005 (KR) 2005-75673

(51) Int. Cl. G01D 11/00; C09D 11/00

(52) U.S. Cl. 347/100; 106/31.46; 106/31.47; 106/31.49; 106/31.76; 106/31.77; 106/31.78; 106/31.43; 106/31.75; 106/31.58; 106/31.86

(57) ABSTRACT

An inkjet ink composition includes water, a colorant, a cyclic amide compound, and a compound of formula I below; an ink cartridge including the same; and an inkjet recording apparatus including the ink cartridge.

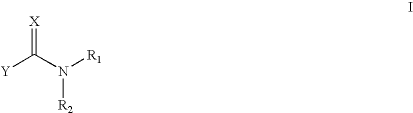

### CROSS-REFERENCE TO RELATED APPLICATIONS

This application claims priority under 35 U.S.C. §119(a) from Korean Patent Application No. 10-2005-0075673, filed on Aug. 18, 2005, in the Korean Intellectual Property Office, the disclosure of which is incorporated herein in its entirety by reference.

### BACKGROUND OF THE INVENTION

1. Field of the Invention

The present general inventive concept relates to an ink composition, an ink cartridge including the same, and an inkjet recording apparatus including the ink cartridge, and more particularly, to an inkjet ink composition in which an interaction between a colorant and a printing medium is reinforced to prevent a deterioration of a printed image quality, while the ink composition is easily infiltrated into the printing medium and thus a drying time of the ink composition is quick; an ink cartridge including the same; and an inkjet recording apparatus including the ink cartridge.

2. Description of the Related Art

In inkjet printing, a character and an image are recorded by ejecting ink droplets on a recording medium, such as a sheet of paper, from a nozzle in a recording head of an inkjet printer to form a point referred to as a “dot.” An ink composition used in the inkjet printing is prepared by dissolving or dispersing a water-soluble dye or pigment in a solvent, such as water.

An inkjet printer can be categorized to a piezoelectric type printer that ejects an ink using a piezoelectric device and thermal type printer that ejects an ink using a thermal device, according to a method of ejecting an ink.

U.S. Pat. No. 5,108,503 describes an ink composition for inkjet recording including 2.5 to 25% by weight of a cyclic amide compound to enhance properties of the ink composition, such as a storage stability and rubbing and water resistances on a paper, but the cyclic amide compound in the ink composition is having a low hygroscopicity (i.e., does not readily absorb water from a surrounding area), and thus the ink composition dries at a nozzle of an inkjet head.

In U.S. Pat. No. 5,145,519, a diol or a polyol, which are solvents having a high boiling point, is used in order to provide an ink composition having excellent fastness.

However, such conventional ink compositions can obtain a desired performance because they include 25% or less by weight of the cyclic amide, or about 30 to 60% by weight of the diol. However, a time that such conventional ink compositions remain on a paper increases, and as a result the paper swells and bleeding between colors becomes severe, thereby deteriorating an image quality of the ink composition. Further, a rubbing resistance that prevents the ink composition from being smeared when rubbing with a hand after the ink composition is dried is weak due to a bad fusibility thereof.

### SUMMARY OF THE INVENTION

The present general inventive concept provides an ink composition that maintains a high solubility and stability of a colorant, thereby enhancing not only a storage stability of the ink composition, but also a fusing property of the ink composition on a printing medium (e.g., paper), thus reinforcing a rubbing resistance thereof. Moreover, the ink composition is easily dried on the printing medium (e.g., the paper), and thus bleeding between colors is minimized, thereby providing an image having a photographic quality.

The present general inventive concept also provides an ink cartridge including the ink composition.

The present general inventive concept also provides an inkjet recording apparatus including the ink cartridge.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet ink composition, including a liquid vehicle, a colorant, a cyclic amide compound, and a compound of formula I below: 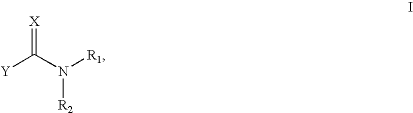
in which R₁ and R₂ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN, X is O or S, and Y is OR₃, NR₄R₅ or R₆, and R₃, R₄, R₅ and R₆ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN.

The cyclic amide compound may include at least one compound selected from the group consisting of 2-pyrrolidone, δ-valerolactam, caprolactam, N-(2-hydroxyethyl)-2-pyrrolidone, and N-cyclohexyl-2-pyrrolidone.

The compound of formula I may include a urea derivative or a thio urea derivative.

An amount of the cyclic amide compound in the ink composition may be about 0.2% to about 40% by weight based on 100% by weight of the ink composition. The amount of the cyclic amide compound in the ink composition may be about 30% to about 40% by weight based on 100% by weight of the ink composition. The amount of the cyclic amide compound in the ink composition may be 26% to about 40% by weight based on 100% by weight of the ink composition.

An amount of the compound of formula I in the ink composition may be about 0.1% to about 20% by weight based on 100% by weight of the ink composition. A weight ratio of the cyclic amide compound to the compound of formula I may be about 1:4 to about 10:1. A weight ratio of the cyclic amide compound to the compound of formula I may be about 1:3 to about 7:1.

An amount of the colorant may be about 0.1% to about 15% by weight based on 100% by weight of the ink composition. The amount of the colorant in the ink composition may be about 1% to about 10% by weight based on 100% by weight of the ink composition.

The ink composition may further include at least one additive selected from the group consisting of a surfactant, a pH controller, a preservative, and a chelating agent. An amount of the at least one additive may be 0.01 to 2 parts by weight based on 1 part by weight of the colorant.

The liquid vehicle may include water.

The foregoing and/or other aspects and utilities of the present general inventive concept may also be achieved by providing an ink cartridge including the ink composition.

The foregoing and/or other aspects and utilities of the present general inventive concept may also be achieved by providing an inkjet recording apparatus including the ink cartridge.

The foregoing and/or other aspects and utilities of the present general inventive concept may also be achieved by providing a composition useable in an inkjet ink, including a cyclic amide compound and a compound of formula I in which R₁ and R₂ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN, X is O or S, and Y is OR₃, NR₄R₅ or R₆, and R₃, R₄, R₅ and R₆ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an inkjet recording apparatus, according to an embodiment of the present general inventive concept; and

FIG. 2 is a sectional view illustrating an ink cartridge, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An inkjet ink composition according to embodiments of the present general inventive concept may include a liquid vehicle (e.g., water), a colorant, a cyclic amide compound, and a compound of formula I below.

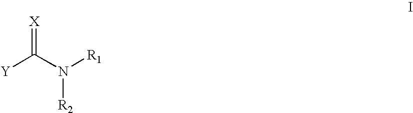

In formula I, R₁ and R₂ may each be independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN. R₁ and R₂ may be identical groups, or may be different groups.

In formula I, X may be O or S.

In formula I, Y may be OR₃, NR₄R₅, or R₆, and R₃, R₄, R₅, and R₆ may each be independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN. R₃, R₄, R₅, and R₆ may each be identical groups, may each be different groups, or may be a mixture of some identical groups and some different groups.

The cyclic amide compound may be, but is not limited to, 2-pyrrolidone, δ-valerolactam, caprolactam, N-(2-hydroxyethyl)-2-pyrrolidone), or N-cyclohexyl-2-pyrrolidone.

The compound of formula I may be selected from, for example, urea, a urea derivative (such as 1,1-diethylurea, 1,3-diethylurea, 1,1-dimethylurea, and 1,3-dimethylurea), a thiourea derivative (such as thiourea, 1,1-diethylthiourea, 1,3-diethylthiourea, 1,1-dimethylthiourea, and 1,3-dimethylthiourea), a carbamate derivative (such as methyl carbamate, and ethyl carbamate), and allyl carbamate.

The compound of formula I (and particularly a urea derivative, a thio urea derivative, and a carbamate derivative) has high water retention. Thus, a congelation and occlusion of the ink composition at an inkjet head nozzle due to the cyclic amide compound (which has a low hygroscopicity, i.e., does not readily absorb water from a surrounding area) can be prevented by including the compound of formula I in the ink composition.

When the cyclic amide compound and the compound of formula I are used in combination, a fusing property of the ink composition on a printing medium (e.g., paper) becomes excellent. An interaction between the cyclic amide compound and the compound of formula I, and/or an interaction between the compounds (i.e., the cyclic amide compound and the compound of formula I) and the colorant and/or the printing medium may act on the fusing property to improve the fusing property, although the improved fusing property of the ink composition according to embodiments of the present general inventive concept is not required to result from these specific mechanisms.

Amounts of the cyclic amide compound and the compound of formula I in the ink composition can vary depending on a desired use of the ink composition, the colorant, or other components of the ink composition. However, the amount of the cyclic amide compound in the ink composition may be, for example, about 0.2% to about 40% by weight based on 100% by weight of the ink composition. For example, the amount of the cyclic amide compound may be about 1.0% to about 20% by weight. Alternatively, the amount of the cyclic amide compound may be about 30% to about 40%, or 26% to about 40%. The amount of the compound of formula I in the ink composition may be, for example, about 0.1% to about 20% by weight based on 100 parts by weight of the ink composition. For example, the amount of the compound of formula I may be about 0.5% to about 15% by weight.

A weight ratio of the cyclic amide compound to the compound of the formula I in the ink composition may be about 1:4 to about 10:1. For example, the weight ratio of the cyclic amide compound to the compound of the formula I in the ink composition may be about 1:3 to about 7:1. If the weight ratio is greater than about 10:1, an improvement in the fusing property on the printing medium cannot be obtained. If the weight ratio is less than about 1:4, the fusing property on the printing medium is good, but a drying of the ink composition on the printing medium (e.g., paper) may be prevented.

The ink composition may include water as a liquid medium (i.e., as the liquid vehicle).

The ink composition may further include a water soluble organic solvent. Examples of the water-soluble organic solvent include, but are not limited to, an aliphatic primary alcohol, a polyhydric alcohol, and a polyhydric alcohol derivative. An amount of the water-soluble organic solvent in the ink composition may be about 1 to about 40% by weight based on 100% by weight of the ink composition. For example, the amount of the water-soluble organic solvent in the ink composition may be about 3 to about 30% by weight.

An aliphatic primary alcohol enhances an infiltrating property of the ink composition on the printing medium, a dot forming ability of the ink composition, and a drying property of an image printed using the ink composition by controlling a surface tension of the ink composition. The polyhydric alcohol and the derivative thereof are not easily evaporated, and thus enhance a storage stability of the ink composition by lowering a freezing point thereof, thereby preventing nozzle occlusion.

Examples of the aliphatic primary alcohol include, but are not limited to, a C₁-C₁₀ lower alcohol, such as methyl alcohol, ethyl alcohol, n-propyl alcohol, i-propyl alcohol, n-butyl alcohol, s-butyl alcohol, or t-butyl alcohol. For example, the aliphatic primary alcohol may be ethyl alcohol, i-propyl alcohol, or n-butyl alcohol.

Examples of the polyhydric alcohol include, but are not limited to, an alkylene glycol (such as ethylene glycol, diethylene glycol, triethylene glycol, propylene glycol, butylene glycol, and glycerol), a polyalkylene glycol (such as polyethylene glycol and polypropylene glycol), a thiodiglycol, and mixtures thereof.

Examples of the polyhydric alcohol derivative include, but are not limited to, a lower alkyl ether of the polyhydric alcohol or a lower carboxylic ester of the polyhydric alcohol. An example of the lower alkyl ether of the polyhydric alcohol includes, but is not limited to, ethylene glycol dimethyl ether. An example of the lower carboxylic ester of the polyhydric alcohol includes, but is not limited to, ethylene glycol diacetate.

The colorant may be, for example, a self-dispersible dye, a self-dispersible pigment, or a conventional pigment used with a dispersant. An amount of the colorant may be about 0.1% to about 15% by weight based on 100% by weight of the ink composition. For example, the amount of the colorant may be about 0.1% to about 10% by weight. Examples of the colorant include, but are not limited to, C.I. Basic Black 2, C.I. Direct Yellow 44, C.I. Basic Blue 26, C.I. Direct Red 227, Projet Fast Cyan 2 (manufactured by Zeneca Company), Projet Fast Magenta 2 (manufactured by Zeneca Company), Projet Fast Yellow 2 (manufactured by Zeneca Company), or Projet Fast Black 2 (manufactured by Zeneca Company).

The ink composition can further include one or more additives, such as one or more of a surfactant, a pH controller, a preservative, and a chelating agent. A total amount of the one or more additives in the ink composition may be about 0.01 to about 2 parts by weight based on 1 part by weight of the colorant.

The inkjet ink composition can be prepared by uniformly mixing the colorant, the liquid vehicle (e.g., water), the cyclic amide, and the compound of formula I using a conventional technique.

The ink composition may be used, for example, in an inkjet printer cartridge that includes an array head. The throughput of an inkjet printer including the cartridge can be increased since the inkjet printer including the array head prints an image at a high speed by employing many chips (unlike a shuttle-type inkjet printer that prints an image using only one chip). Further, an ink cartridge including the ink composition may be used in an inkjet recording apparatus.

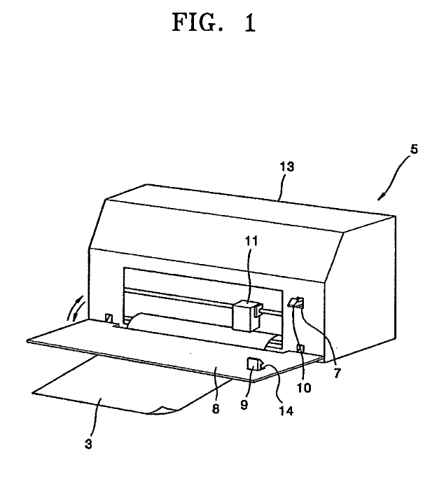

FIG. 1 is a perspective view illustrating an inkjet recording apparatus, according to an embodiment of the present general inventive concept. Referring to FIG. 1, an inkjet recording apparatus 5, according to an embodiment of the present general inventive concept, includes an ink cartridge 11 including an ink composition. The ink composition may include a compound of the formula I, a colorant, a water-soluble solvent and water. A printer cover 8 is connected through a hinge with a main body 13 of the inkjet recording apparatus 5. A region of a moving latch 10 protrudes through a hole 7. The moving latch 10 is engaged with a fixed latch 9, and the fixed latch 9 is connected to the inside of the printer cover 8 when the printer cover 8 is closed. The printer cover 8 has a recess 14 corresponding to the region of the moving latch 10 protruding through the hole 7. The ink cartridge 11 is mounted in the main body 13 and ink is ejected on a printing medium, such as a piece of paper 3, passing through the lower part of the ink cartridge 11.

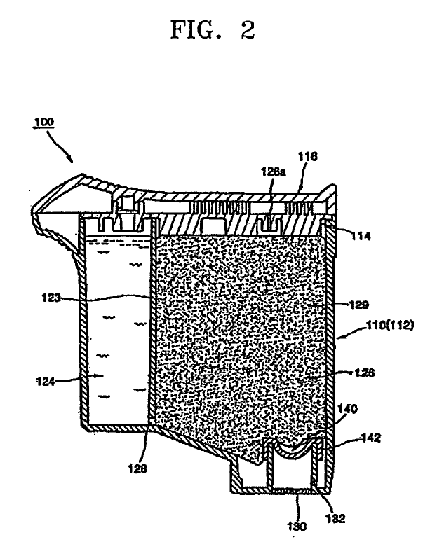

FIG. 2 is a sectional view illustrating an ink cartridge 100, according to an embodiment of the present general inventive concept. The ink cartridge 100 may include an inkjet ink composition including a compound of the formula I, a colorant, a water-soluble solvent and water according. The ink cartridge 100 includes a main body 110 forming an ink receiver 112, an inner cover 114 covering a top region of the ink receiver 112, and an outer cover 116 spaced apart from the inner cover 114 at a predetermined interval and sealing the ink receiver 112 and the inner cover 114.

The ink receiver 112 is divided into a first chamber 124 and a second chamber 126 by a vertical barrier wall 123. An ink passage 128 is formed in a lower part of the vertical barrier wall 123 between the first chamber 124 and the second chamber 126. Ink is filled into the first chamber 124 and a sponge 129, and then the second chamber 126. A vent hole 126a corresponding to the second chamber 126 is formed in the inner cover 114.

A filter 140 to prevent a nozzle 130 of a printer head from clogging is formed in a lower part of the second chamber 126 to filter impurities and minute bubbles from the ink. A hook 142 is formed in an edge region of the filter 140 and coupled to the top region of a standpipe 132. Ink in the ink receiver 120 passes through the nozzle 130 of the printer head and is ejected as small droplets on the printing medium.

The present general inventive concept will be described in greater detail with reference to the following examples. The following examples are for illustrative purposes only and are not intended to limit the scope of the general inventive concept.

### EXAMPLES

Inkjet ink compositions according to embodiments of the present general inventive concept were obtained by thoroughly mixing components described in Examples 1-4 below with a mixer. All amounts are measured in % weight based on 100% by weight of the respective ink composition.

### Example 1

| | |
|---|---|
| C.I. Basic Black 2 | 4.0% by weight |
| Glycerol | 7.0% by weight |
| Diethylene glycol | 7.0% by weight |
| Urea | 3.5% by weight |
| 2-pyrrolidone | 5.0% by weight |
| Water (Deionized water) | 73.5% by weight |

### Example 2

| | |
|---|---|
| C.I. Direct Yellow 44 | 4.0% by weight |
| Glycerol | 9.5% by weight |
| Diethylene glycol | 5.5% by weight |
| Ethylene glycol | 4.5% by weight |
| Caprolactam | 3.0% by weight |
| 1,1-dimethylurea | 5.5% by weight |
| Water (Deionized water) | 68.0% by weight |

### Example 3

| | |
|---|---|
| C.I. Basic Blue 26 | 4.5% by weight |
| Diethylene glycol | 9.5% by weight |
| Ethylene glycol | 10.5% by weight |
| N-(2-hydroxyethyl)-2-pyrrolidone | 3.5% by weight |
| 1,3-diethylurea | 2.5% by weight |
| Water (Deionized water) | 69.5% by weight |

### Example 4

| | |
|---|---|
| C.I. Direct Red 227 | 3.5% by weight |
| Glycerol | 10.5% by weight |
| Diethylene glycol | 4.5% by weight |
| Ethylene glycol | 5.5% by weight |
| N-cyclohexyl-2-pyrrolidone | 3.0% by weight |
| Methyl carbamate | 2.5% by weight |
| Water (Deionized water) | 69.5% by weight |

Comparative inkjet ink compositions were obtained by thoroughly mixing components described in Comparative Examples 1-4 below with a mixer.

### Comparative Example 1

| | |
|---|---|
| C.I. Basic Black 2 | 4.0% by weight |
| Glycerol | 7.0% by weight |
| Diethylene glycol | 7.0% by weight |
| Urea | 8.5% by weight |
| Water (Deionized water) | 73.5% by weight |

### Comparative Example 2

| | |
|---|---|
| C.I. Direct Yellow 44 | 4.0% by weight |
| Glycerol | 9.5% by weight |
| Diethylene glycol | 5.5% by weight |
| Ethylene glycol | 4.5% by weight |
| 1,1-dimethylurea | 8.5% by weight |
| Water (Deionized water) | 68.0% by weight |

### Comparative Example 3

| | |
|---|---|
| C.I. Basic Blue 26 | 4.5% by weight |
| Diethylene glycol | 9.5% by weight |
| Ethylene glycol | 10.5% by weight |
| N-(2-hydroxyethyl)-2-pyrrolidone | 6.0% by weight |
| Water (Deionized water) | 69.5% by weight |

### Comparative Example 4

| | | |
|---|---|---|
| C.I. Direct Red 227 | 3.5% | by weight |
| Glycerol | 10.5% | by weight |
| Diethylene glycol | 4.5% | by weight |
| Ethylene glycol | 5.5% | by weight |
| N-cyclohexyl-2-pyrrolidone | 5.5% | by weight |
| Water (Deionized water) | 69.5% | by weight |

Evaluation Experiment #1: Dryness on a Printing Medium

The ink compositions obtained from Examples 1-4 and Comparative examples 1-4 were refilled in an ink cartridge P-50 or C-60 (manufactured by Samsung Electronics Co., Ltd.). Then, immediately after a bar picture (3×20 cm) was printed on a photo glossy paper using a printer (MJC-3300P, manufactured by Samsung Electronics Co., Ltd.), a second paper was put on the printed face of the glossy paper and the two papers were passed together through a press roll tester, and then the OD (optical density) value of the image that was transferred from the bar picture was compared to the OD value of the image before passage through the press roll tester. The results in percentage are described in Table 1 below, based on the following criteria, where A=(OD of transferred image/OD of original bar picture)×100:

⊚: A<15.

O: 15≦A<30.

X: 30≦A<45.

XX: A>45.

Evaluation Experiment #2: Rubbing Resistance

The ink compositions obtained from Examples 1-4 and Comparative Examples 1-4 were refilled in P-50 cartridge and C-60 cartridge, a character and a solid image were printed on a general sheet of paper using a MJC-3300P Samsung printer, and then the resultant print was dried for 24 hours in the air. The printed image was rubbed with a hand at 25° C., in a 50% RH environment, and the results were evaluated with naked eyes and described in Table I below, based on the following criteria:

O: image was not spotted.

X: image was slightly spotted, but the character was legible.

XX: image was so spotted that the character was illegible.

Evaluation Experiment #3: Occlusion at Nozzles

Of the ink compositions obtained from Examples 1-4 and Comparative Examples 1-4, color ink was refilled in an ink cartridge C-60 (manufactured by Samsung Electronics Co., Ltd.) and black ink was refilled in an ink cartridge M-50 (manufactured by Samsung Electronics Co., Ltd.). Then, when the ink cartridges were used to print after standing for 2 weeks at ambient temperature (25° C.) and low temperature (−18° C.), respectively, a number of times that the nozzles needed to be cleaned for normal printing was determined, and the evaluation results are described in Table 1 below, based on the following criteria:

⊚: normal printing was possible when cleaning nozzles one time.

O: normal printing was possible when cleaning nozzles 2 to 4 times.

X: normal printing was possible when cleaning nozzles 5 to 10 times.

XX: normal printing was not possible even when cleaning nozzles 10 times.

TABLE 1

| | | Rubbing | Occlusion |
|---|---|---|---|
| | Dryness | resistance | at nozzles |
| Example 1 | ⊚ | ◯ | ◯ |
| Example 2 | ⊚ | ◯ | ⊚ |
| Example 3 | ◯ | ◯ | ◯ |
| Example 4 | ◯ | ◯ | ⊚ |
| Comparative example 1 | XX | X | X |
| Comparative example 2 | XX | XX | X |
| Comparative example 3 | X | XX | XX |
| Comparative example 4 | X | X | X |

As described in Table 1, the ink compositions of Examples 1-4 are easily dried on the paper (as compared to Comparative Examples 1-4, which do not include a combination of a cyclic amide compound and a compound of formula I), thereby minimizing bleeding between colors. Furthermore, the ink compositions of Examples 1-4 have an excellent fusing stability on the paper (as compared to Comparative Examples 1-4, which do not include a combination of a cyclic amide compound and a compound of formula I), resulting in an excellent rubbing resistance, and thus enabling the printing of an image having a photographic quality.

An ink composition for inkjet recording according to embodiments of the present general inventive concept maintains a high stability of a colorant, prevents congelation and occlusion of the ink composition at a surface of a nozzle in an ink head, and enhances a fusing property of the ink composition on a printing medium.

An ink composition according to embodiments of the present invention maintains a high solubility and stability of a colorant, thereby enhancing not only a storage stability of the ink composition, but also a fusing property of the ink composition on a paper, thus reinforcing a rubbing resistance thereof. Further, the ink composition is easily dried on the paper, and thus bleeding between colors is minimized, thereby improving a printed image quality with little or no solvent having a high boiling point in the ink composition.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. An inkjet ink composition, comprising:
a liquid vehicle;
a colorant;
a cyclic amide compound; and
a compound of formula I below: 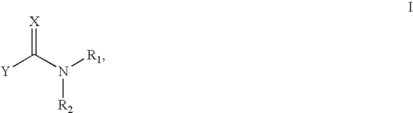
wherein:
R₁ and R₂ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN,
X is O or S, and
Y is OR₃, NR₄R₅ or R₆, and R₃, R₄, R₅ and R₆ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN.

2. The ink composition of claim 1, wherein the cyclic amide compound comprises at least one compound selected from the group consisting of 2-pyrrolidone, δ-valerolactam, caprolactam, N-(2-hydroxyethyl)-2-pyrrolidone, and N-cyclohexyl-2-pyrrolidone.

3. The ink composition of claim 1, wherein the compound of formula I comprises a urea derivative or a thio urea derivative.

4. The ink composition of claim 1, wherein the compound of formula I is at least one compound selected from the group consisting of urea, 1,1-diethylurea, 1,3-diethylurea, 1,1-dimethylurea, 1,3-dimethylurea, thiourea, 1,1-diethylthiourea, 1,3-diethylthiourea, 1,1-dimethylthiourea, and 1,3-dimethylthiourea.

5. The ink composition of claim 1, wherein an amount of the cyclic amide compound in the ink composition is about 0.2% to about 40% by weight based on 100% by weight of the ink composition.

6. The ink composition of claim 1, wherein an amount of the cyclic amide compound in the ink composition is about 30% to about 40% by weight based on 100% by weight of the ink composition.

7. The ink composition of claim 1, wherein an amount of the cyclic amide compound in the ink composition is 26% to about 40% by weight based on 100% by weight of the ink composition.

8. The ink composition of claim 1, wherein an amount of the compound of formula I is about 0.1% to about 20% by weight based on 100% by weight of the ink composition.

9. The ink composition of claim 1, wherein a weight ratio of the cyclic amide compound to the compound of formula I is about 1:4 to about 10:1.

10. The ink composition of claim 1, wherein a weight ratio of the cyclic amide compound to the compound of formula I is about 1:3 to about 7:1.

11. The ink composition of claim 1, further comprising:
a water-soluble organic solvent.

12. The ink composition of claim 11, wherein the water-soluble organic solvent is at least one solvent selected from the group consisting of an aliphatic primary alcohol, a polyhydric alcohol, and a polyhydric alcohol derivative.

13. The ink composition of claim 12, wherein an amount of the water-soluble organic solvent in the ink composition is about 1% to about 40% by weight based on 100% by weight of the ink composition.

14. The ink composition of claim 12, wherein an amount of the water-soluble organic solvent in the ink composition is about 3% to about 30% by weight based on 100% by weight of the ink composition.

15. The ink composition of claim 1, wherein the colorant comprises at least one of a dye, a pigment, and a self-dispersible pigment.

16. The ink composition of claim 15, wherein an amount of the colorant in the ink composition is about 0.1% to about 15% by weight based on 100% by weight of the ink composition.

17. The ink composition of claim 15, wherein an amount of the colorant in the ink composition is about 1% to about 10% by weight based on 100% by weight of the ink composition.

18. The ink composition of claim 1, further comprising:
at least one additive selected from the group consisting of a surfactant, a pH controller, a preservative, and a chelating agent.

19. The ink composition of claim 18, wherein an amount of the at least one additive is 0.01 to 2 parts by weight based on 1 part by weight of the colorant.

20. The ink composition of claim 1, wherein the liquid vehicle comprises water.

21. An ink cartridge, comprising an ink composition comprising:
a liquid vehicle;
a colorant;
a cyclic amide compound; and
a compound of formula I below: 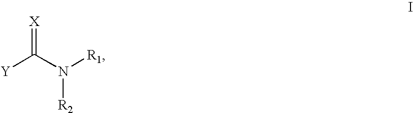
wherein:
R₁ and R₂ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN,
X is O or S, and
Y is OR₃, NR₄R₅ or R₆, and R₃, R₄, R₅ and R₆ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN.

22. An inkjet recording apparatus, comprising an ink cartridge comprising an ink composition, the ink composition comprising:
a liquid vehicle;
a colorant;
a cyclic amide compound; and
a compound of formula I below: 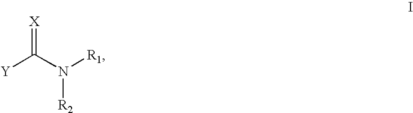
wherein:
R₁ and R₂ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN,
X is O or S, and
Y is OR₃, NR₄R₅ or R₆, and R₃, R₄, R₅ and R₆ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN.

23. A composition useable in an inkjet ink, comprising:
a cyclic amide compound; and
a compound of formula I 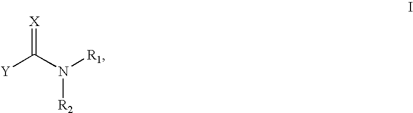
wherein:
R₁ and R₂ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN,
X is O or S, and
Y is OR₃, NR₄R₅ or R₆, and R₃, R₄, R₅ and R₆ are each independently selected from a hydrogen atom, a substituted or unsubstituted C1-C20 alkyl group, a substituted or unsubstituted C6-C20 aryl group, a substituted or unsubstituted C3-C20 heteroaryl group, a substituted or unsubstituted C2-C12 alkenyl group, a substituted or unsubstituted C7-C20 arylalkyl group, a substituted or unsubstituted C1-C6 alkoxy group, a halogen, NO₂, and CN.
